(19) United States
(12) Patent Application Publication
(10) Pub. No.: US 2025/0014018 A1
(43) Pub. Date: Jan. 9, 2025

(54) Physical and Digital Card

(71) Applicant: Bank of America Corporation, Charlotte, NC (US)

(72) Inventors: Shola L. Oni, Atlanta, GA (US); Vijaya L. Vemireddy, Plano, TX (US); Jennifer T. Renckert, Middleburg, FL (US); Jinna Kim, Charlotte, NC (US)

(73) Assignee: Bank of America Corporation, Charlotte, NC (US)

(21) Appl. No.: 18/218,729

(22) Filed: Jul. 6, 2023

(51) Int. Cl. G06Q 20/34; G05B 19/4099; G06K 19/06

(52) U.S. Cl. CPC G06Q 20/355; G05B 19/4099; G06K 19/06037; G06Q 20/405; G05B 2219/49023

(57) ABSTRACT

Aspects of the disclosure relate to a method of generating a personalized payment card. In some arrangements, the generated payment card may include on board circuitry and architecture to prevent unauthorized use of the payment card. In some instances, the generated payment card may be a temporary payment card with a fixed transaction limit amount that may or may not be reloadable. The designed personalized payment card may be 3D printed and initialized by a card generating and alerting computing platform.

### BACKGROUND

Aspects of the disclosure relate to electrical computers, systems, and devices for generating personalized payment cards. Currently, payment cards are produced and sent to users through the mail. Customization of physical and digital payment cards are limited to institution offerings. Furthermore, the onboarding process to obtain and finally receive a requested payment card is time consuming for all parties involved. There is a need to develop a capability for account owners to generate personalized payment cards on demand to remove these bottlenecks.

### SUMMARY

In light of the foregoing background, the following presents a simplified summary of the present disclosure in order to provide a basic understanding of various aspects of the disclosure. The summary is not limiting with respect to the exemplary aspects of the disclosure described herein and is not an extensive overview of the disclosure. It is not intended to identify key or critical elements of or steps in the disclosure or to delineate the scope of the disclosure. Instead, as would be understood by a person of ordinary skill in the art, the following summary merely presents some concepts of the disclosure in simplified form as a prelude to the more detailed description provided below. Moreover, sufficient written descriptions of the embodiments of this application are disclosed in the specification throughout this application along with exemplary, non-exhaustive, and non-limiting manners and processes of making and using the inventions, in such full, clear, and concise, and exact terms in order to enable skilled artisans to make and use the inventions without undue experimentation and sets forth the best mode contemplated by the inventors for carrying out the invention.

Aspects of this disclosure address one or more shortcomings in the industry by providing a method of generating a personalized payment card. In some embodiments, the generated payment card may include on board circuitry and architecture to prevent unauthorized use of the payment card. In some instances, the generated payment card may be a temporary payment card with a fixed transaction limit amount that may or may not be reloadable. In some arrangements, a user designed personalized payment card may be 3D (three-dimensional) printed and initialized by a card generating and alerting computing platform.

In accordance with one or more embodiments, a payment device may capture images of the generated payment card in contact with a payment device. The captured images may be analyzed to determine authenticity of the generated payment card. An alert may be generated upon detection of any suspicious or fraudulent payment card.

In an aspect of the disclosure, a computing environment may include one or more data centers and one or more computing devices, including computing devices located at or within such data centers and computing devices not located at or within such data centers. For example, a computing environment may include a first data center. The data center may include a card generating and alerting computing platform. The computing environment may also include a user device, a point-of-sale terminal, and/or an ATM.

In some arrangements, a data center may be a distinct and physically separate data center operated by and/or otherwise associated with an organization, such as a financial institution. In addition, the data center may house a plurality of server computers and various other computers, network components, and devices.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1 illustrates a computing environment for generating a payment card in accordance with one or more aspects described herein;

FIG. 2 illustrates a payment card in accordance with one or more aspects described herein;

FIG. 3 illustrates exemplary payment card design features in accordance with one or more aspects described herein;

FIG. 4 illustrates exemplary generated payment cards included in various objects in accordance with one or more aspects described herein;

FIG. 5 depicts an illustrative block diagram for detecting a suspicious payment card in accordance with one or more aspects described herein; and

FIG. 6 depict an illustrative block diagram for generating a payment card in accordance with one or more aspects described herein

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is also noted that these connections are general and, unless specified otherwise, may be direct or indirect, wired or wireless, and that the specification is not intended to be limiting.

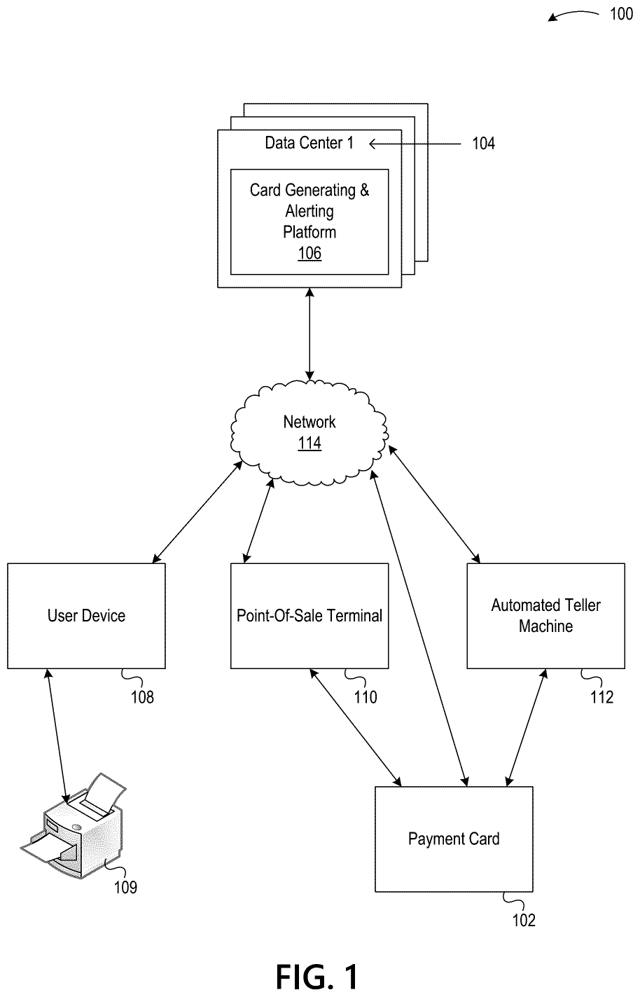

FIG. 1 depicts an illustrative computing environment 100 for generating a payment card 102 with various embodiments of the disclosure. In an embodiment, payment card 102 may include a contactless payment card. In alternative embodiments, payment card 102 may include a debit card, gift card, store merchandise card, prepaid card, and/or digital card.

Computing environment 100 may include one or more data centers and one or more computing devices, including computing devices located at or within such data centers and computing devices not located at or within such data centers. For example, computing environment 100 may include a first data center 104. Data center 104 may include a card generating and alerting computing platform 106. Computing environment 100 also may include a user device 108, a 3D printer 109, a point-of-sale terminal 110, and/or an automated teller machine 112.

Data center 104 may be a distinct and physically separate data center operated by and/or otherwise associated with an organization, such as a financial institution. In addition, data center 104 may house a plurality of server computers and various other computers, network components, and devices.

In an aspect of the disclosure, a card generating and alerting computing platform 106 may be configured to provide one or more portal interfaces to one or more client devices and/or may be configured to authenticate and/or monitor one or more payment cards and associated acceptance devices such as point-of-sale terminals, and/or automated teller machines.

In another aspect of the disclosure, card generating and alerting computing platform 106 may be configured to authenticate payment cards that transact with card readers. In some instances, a snapshot or digital images taken of a payment card 102 upon insertion into a card reader may be analyzed by card generating and alerting computing platform 106 for suspicious or fraudulent activity. In an embodiment, card generating and alerting computing platform 106 may determine authenticity of a payment card used in a transaction.

In some arrangements, data center 104 may include one or more client account servers, which may be configured to store and/or maintain information associated with one or more client accounts. For example, the client account server(s) may be configured to store and/or maintain information associated with one or more financial accounts associated with one or more customers of a financial institution, such as account balance information, transaction history information, and/or the like. In an embodiment, client account server(s) may store information regarding the background type and branding of customers issued payment cards. This information may also include digital images of a customers issued payment cards to be used for authentication purposes in real-time financial transactions.

Additionally or alternatively, client account server(s) may include and/or integrate with one or more client support servers and/or devices, such as one or more customer service representative devices used by one or more customer service representatives of an organization (which may, e.g., be a financial institution operating data center 106), to connect one or more customers of the organization with one or more customer service representatives of the organization via one or more telephone support sessions, chat support sessions, and/or other client support sessions.

In one or more arrangements, a user device 108 may be any type of computing device capable of receiving a user interface, receiving input via the user interface, and communicating the received input to one or more other computing devices. For example, a user device may, in some instances, be and/or include server computers, desktop computers, laptop computers, tablet computers, smart phones, or the like that may include one or more processors, memories, communication interfaces, storage devices, and/or other components. As noted above, and as illustrated in detail below, a user device may, in some instances, be one or more special-purpose computing devices configured to perform specific functions. In an embodiment, user device 108 may receive alerts or communications from card generating and alerting computing platform 106 regarding current or past transactions.

In an embodiment, user device 108 may communicate with card generating and alerting computing platform 106 to provide a user with information related to current or previous transactions. In some instances, in addition to being configured to provide uses with transactional information, card generating and alerting computing platform 106 also may be configured to provide a mobile banking portal associated with the financial institution to various customers of the financial institution and/or their associated mobile computing devices. Such portals may, for instance, provide customers of the financial institution with access to financial account information (e.g., account balance information, purchase transactions, account statements, recent transaction history information, or the like) and/or may provide customers of the financial institution with menus, controls, and/or other options to schedule and/or execute various transactions (e.g., online bill pay transactions, person-to-person funds transfer transactions, or the like). A card generating and alerting computing platform 106 may be configured to provide one or more interfaces that allow for configuration and management of one or more cards, computing devices, and/or computer systems included in the computing environment.

In an embodiment, a computing environment also may include one or more computing platforms. For example, a computing environment may include a card generating and alerting computing platform 106. As illustrated in greater detail below, a card generating and alerting computing platform 106 may include one or more computing devices configured to perform one or more of the functions described herein. For example, a card generating and alerting computing platform 106 may include one or more computers (e.g., laptop computers, desktop computers, servers, server blades, or the like). The computing environment also may include one or more networks 114, which may interconnect one or more of card generating and alerting computing platforms, a user device 108, a point-of-sale terminal 110, and/or an automated teller machine 112. For example, a computing environment may include a network 114, which may include one or more public networks, one or more private networks, and/or one or more sub-networks (e.g., local area networks (LANs), wide area networks (WANs), or the like).

The computing environment also may include one or more card interface devices, such as point-of-sale terminal 110 and/or ATM 112. A point-of-sale terminal 110 and/or an ATM 112 may include a card-reading interface, such as an EMV chip interface, an image capture device, a magnetic stripe reader, a QR reader, and/or a contactless reader (e.g., near-field communication (NFC), radio-frequency identification (RFID)). The one or more card interface devices, such as point-of-sale terminal 110 and/or automated teller machine 112, are connected to a power source. The one or more card interface devices, such as a point-of-sale terminal 110 and/or ATM 112, may be configured to send information to and receive information from the card generating and alerting computing platform 106. This may include, for example, card authentication information, image capture data, purchase information, QR codes, and/or card update information (e.g., updated card number, expiration date, name, offers, or the like for display).

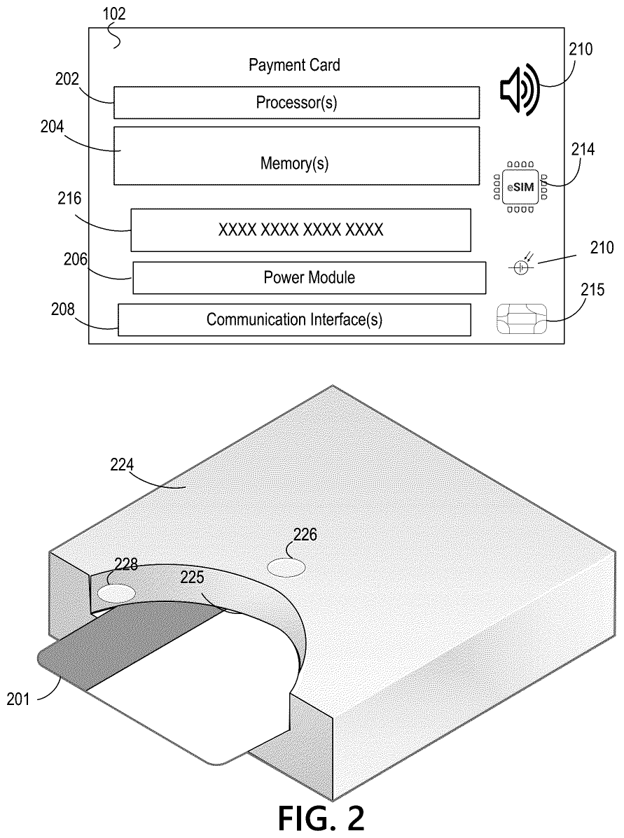

The computing environment may also include one or more contactless payment cards 102 (e.g., smart contactless credit cards, debit cards, ATM cards). As shown in FIG. 2, in some arrangements of the disclosure, a contactless payment card 102 may include magnetic stripe 201, one or more processors 202, memory 204, a power module 206, a communication interface 208, a speaker 210, a photovoltaic 212, and a micro-embedded eSIM 214. In an alternative embodiment, contactless payment card 102 may include a battery or similar power sources. In an embodiment, eSIM 214 may be used to pair with other smart contactless payment cards to form a card-pairing network to share information. The card-pairing network may also be connected with other backend networks associated with card generating and alerting computing platform 106.

In some arrangements a data bus may interconnect the one or more processors, memory, and communication interface. The communication interface may be a chip (e.g., an EMV chip 215) configured to support communication between smart contactless payment card and an interface device (e.g., an EMV chip reader of a point-of-sale terminal or automated teller machine). The chip may be configured to draw power (e.g., electrical current) from the interface device when connected to the interface device. In some embodiments, the EMV chip may be configured according to ISO/IEC 7816 standard. In some other embodiments, the EMV chip may include a contactless chip, such as a contactless chip configured according to ISO/IEC 14443 standard.

Memory may include one or more program modules having instructions that when executed by processor cause the contactless payment card 102 to perform one or more functions described herein. In some instances, the one or more program modules may be stored by and/or maintained in different memory units of the contactless payment card. In some instances, the one or more program modules may be instantiated in custom chips or integrated circuits, such as a custom chip configured to perform set pre-programmed logic.

FIG. 2 illustrates a payment card interface device 224 that may be included in a point-of-sale terminal 110 and/or ATM 112. Payment card interface device 224 may accept a payment card 102 by inserting payment card 102 into a front slot 225 of payment card interface device 224. If the payment card 102 has an embedded chip, payment card 102 may remain in the payment card interface device 224 until transaction completion. Upon insertion of payment card 102, a digital image of payment card 102 may be captured by imaging sensor 226. Image sensor 226 may utilize visible light or in other embodiments infrared, or ultraviolet wavelengths. In some arrangements, the imaging sensor or sensors may capture multispectral images. Filters may be applied to the multispectral images to separate different detected wavelengths.

In an aspect of the disclosure, multiple image sensors may be embedded into payment card interface device 224 so that digital images of both sides of inserted payment cards may be captured. In additional embodiments, image sensors such as image sensor 228 may be placed on different internal and external surfaces of payment card interface device 224 to capture images of contactless payment cards or magnetic stripe payment cards. One skilled in the art will realize that numerous different designs of payment card interface devices exist and that image sensor device placement may be different in each of these designs in order to capture digital images of the utilized payment card.

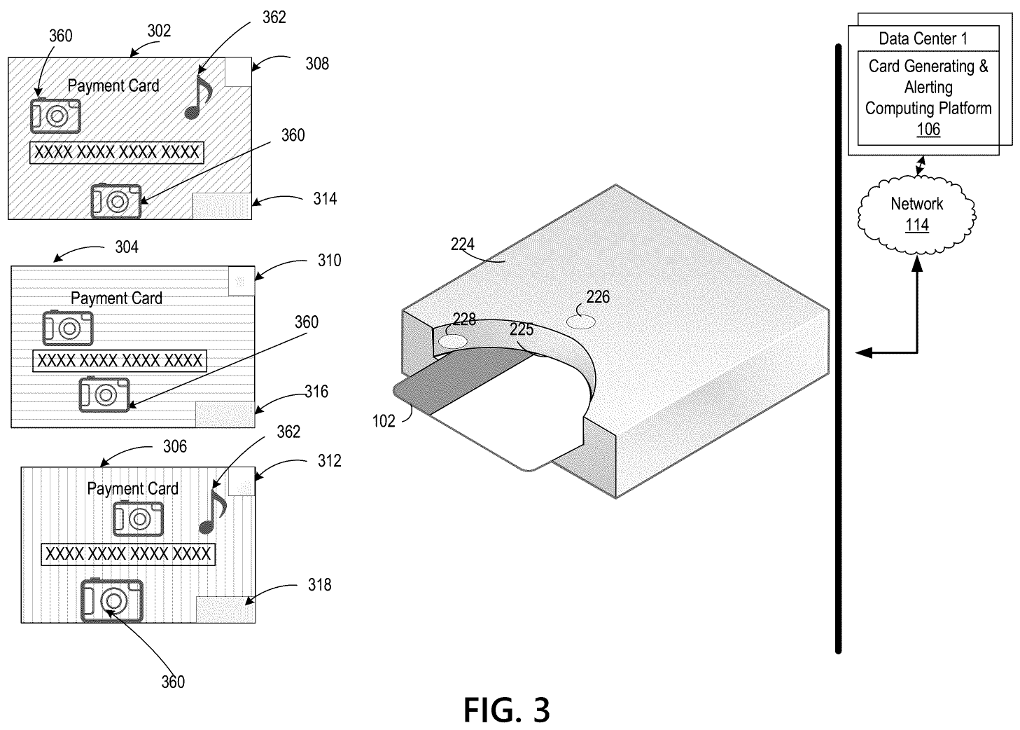

FIG. 3 illustrates different exemplary payment card background designs in accordance with various aspects of the disclosure. In FIG. 3, payment cards 302, 304, and 306 each have different imprinted background designs that distinguish each of payment cards 302, 304, 306. In an embodiment, users may design various aspect of payment cards 302, 304, and 306. The design aspects may include the addition of photos 360, audio clips 362, and video segments. Different user created background designs may include graphics, symbols, pictures, logos, colors or other image or audio details that may be imprinted or embedded onto or into the payment card.

In an aspect of the disclosure, a user may design a new payment card with numerous personalized features in order to customize their payment card. Once a user has completed their design, a payment card initialization request may be forwarded to card generating and alerting platform 106 for generation and initialization. Card generation and alerting platform 106 may analyze and determine based on the received initialization request and design features if a payment card should be generated. The determination may be based on predetermined financial institution criteria. If approved, card generating and alerting platform 106 may forward the new payment card to user for use in executing transactions.

In another embodiment, a user device may utilize 3D printer 109 to generate a new personalized card based on their completed design. Once a user has completed their design, a payment card initialization request may be forwarded to card generating and alerting platform 106 for generation and initialization. Card generation and alerting platform may analyze and determine based on the received initialization request and design features if a payment card should be generated. The determination may be based on predetermined financial institution criteria. If approved, card generating and alerting platform 106 may issue and transmit to a user device a bank identification number (bin), expiration date, and CVV code to be included in the new design. Card generating and alerting computing platform 106 may transmit the authorization with updated design information to the user device. The user device with the received authorization and updated design information generate the new payment card using 3D printer 109.

In some arrangements, card generating and alerting computing platform 106 may include a QR code or other information for the payment card that may not be decipherable or detectable to the human eye. Such information by be detected by various different sensors using different visible or non-viable light spectrums. In an embodiment, payment cards may include a particular area on each payment card in which card generating and alerting computing platform 106 may insert additional unique information detectable only by sensors to assist in identifying authorized payment and assist in detecting fraudulent and/or cloned cards.

In another aspect of the disclosure, on some payment cards the issuer's logo or other identifiable information may be displayed on the payment card such as in a corner of the cards as shown at 308, 310, and 312. Moreover, the financial network the card belongs to may also be indicated on the face of the card such as shown in the lower right-hand corner of payment cards 302, 304, and 306, as boxes 314, 316, and 318.

In another aspect of the disclosure, card generating and alerting computing platform 106 may forward to a user a predetermined kit of materials to be used in generating and 3D printing a new user designed payment card. The predetermined kit may induce a circuit board that includes component such as one or more processors 202, memory 204, a power module 206, a communication interface 208, a speaker 210, a photovoltaic 212, a micro-embedded eSIM 214, and an EMV chip 215. The predetermined kit may also include templates or computer files for use by 3D printer 109 in printing the new payment card. In an embodiment, an image of the user completed payment card design may be transmitted to card generating and alerting computing platform 106 for initialization. Card generating and alerting computing platform 106 may review the image of the user payment card design and issue a bank identification number (bin), expiration date, and CVV code to be included in the new design. In some arrangements, card generating and alerting computing platform 106 may include a QR code or other information for the payment card that may not be decipherable or detectable to the human eye. Such information may be detected by various different sensors using different visible or non-viable light spectrums. Card generating and alerting computing platform 106 may transmit an authorization message with updated information for printing the new user designed payment card on 3D printer 109.

In an aspect of the disclosure, when payment card 102 is inserted into payment card interface device 224, imaging sensor 226 detects and captures at least one digital image of payment card 102. The captured digital images may be used to analyze and characterize the inserted payment card 102. For instance, captured digital images may be used to determine if payment card 102 is an authentic payment card. In an embodiment, the captured digital images may be compared to stored initialized cards to determine if the payment card is an authorized payment card.

In an embodiment, the analysis of the payment card from the captured images may determine the amount of red, green and/or blue color used in the overall payment card or in certain parts of the payment card and compare the detected color amount to stored initialized cards. In an embodiment, the analysis detects or determines any unique features of different payment cards that may have been used by card users when designing their payment cards. These features may be used to detect legitimate payment cards. In yet another embodiment, card generating and alerting computing platform 106 may be used to compare the captured digital images and the information determined from the analysis to stored backgrounds for payment cards designed by users. If the background or other features determined in the captured digital images does not match stored images of legitimate issued backgrounds designed by users, the financial transaction may be canceled.

In an aspect of the disclosure, payment card interface device 224 utilizing imaging sensor 226 may capture images of a payment card's EMV chip. In an embodiment, payment card issuers may track the different types of EMV chips utilized in each of their different types of payment cards. The captured images of a payment card's EMV chip may be compared to stored information on the EMV chip embedded in payment card at card generation. For example, the captured images may be used to determine the trace line patterns of the payment card's EMV chip for comparison to the stored information about the EMV chip at time of generation. If the trace patterns do match the stored information, the payment card interface device 224 may flag the payment card as being a cloned card.

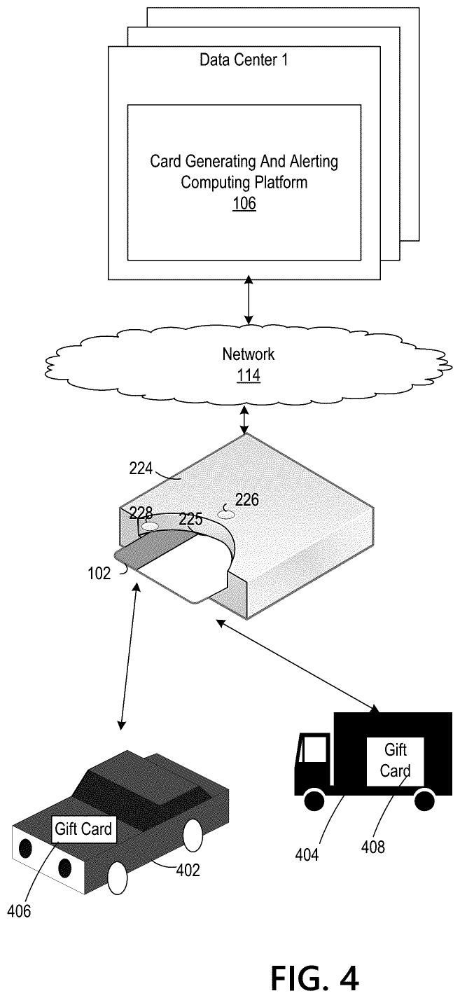

FIG. 4 illustrates an exemplary generated payment card embedded in various objects in accordance with an aspect of the disclosure. For instance, FIG. 4 show a toy car 402 and toy truck 404 that may be presented as a gift at a birthday party. Both the toy car 402 and truck 404 may include a payment card 406 and 408 (in the form of gift cards). The generated payment cards 406 and 408 may be used to provide a monetary gift in addition to the presented toy. Payment cards 406 and 408 may include all the components discussed above with respect to payment card 302, 304, and 306. In some arrangements, payment cards 406 and 408 may upon use at a payment card interface device play music such as the “Happy Birthday to You” song further providing birthday wishes to the toy recipient. Additional personal messages may also be recorded and played upon presentation of the toy to payment card interface device 224.

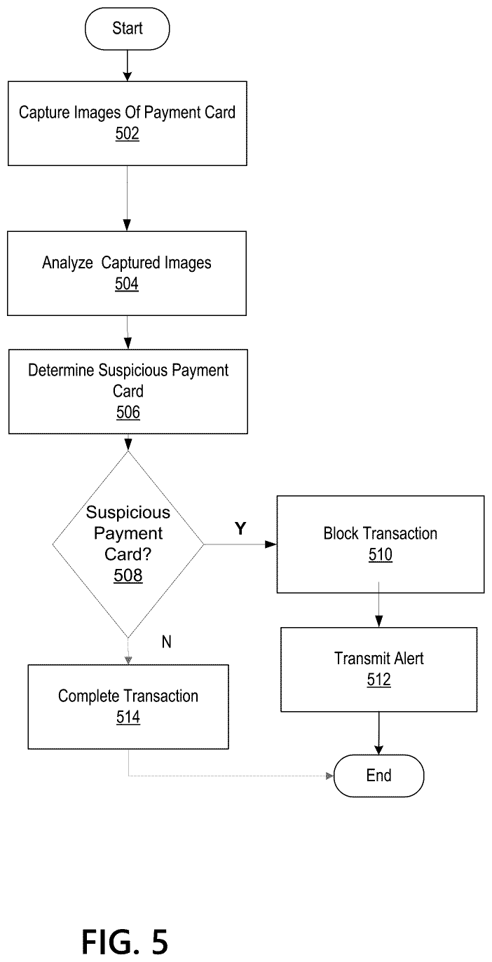

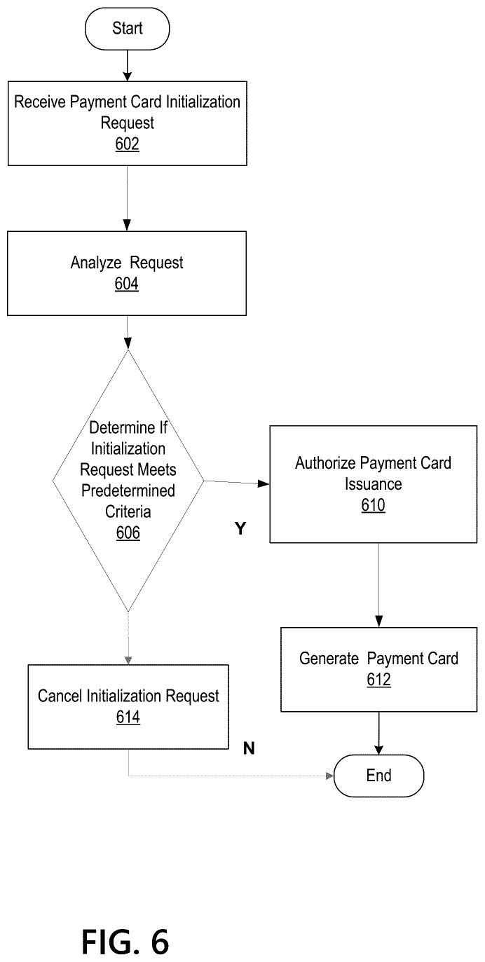

FIG. 5 illustrates an exemplary method for detecting a suspicious payment card in accordance with one or more embodiments of the disclosure. Referring to FIG. 6, the process is initiated by bringing the payment card 102 within range of the card reader or payment card interface device 224. In an embodiment, a user may be attempting to purchase an item or service using their payment card 102.

At step 502, payment card interface device 224 captures at least one image of the payment card. In steps 504 and 506, payment card interface device 224 analyzes the at least one image and determines if the payment card 102 is suspicious before transaction authorization. In an embodiment, payment card interface device 224 captures images of the payment card using optical sensors 226. If in step 508, payment card 102 is determined to be suspicious then the transaction is blocked in step 510 and alerts are transmitted in step 512.

If in step 508, the payment card 102 is not determined to be suspicious then the process continues with normal payment processing techniques including card processing, card network processing, and transaction completion.

FIG. 6 illustrates an exemplary method for generating a personalized payment card in accordance with one or more embodiments of the disclosure. Referring to FIG. 6, at step 602 card generating and alerting platform 106 may receive a payment card initialization request. The payment card initialization request may include payment card design features for a payment card. In step 604, card generating and alerting platform 106 may analyze the request including the payment card design features for the payment card. In step 606, card generating and alerting platform 106 may determine if the initialization request and the payment design features meet predetermined criteria. If card generating and alerting platform 106 determines that the initialization request and the payment design features meets predetermined criteria, a payment card is authorized in step 610 and generated in step 612. If card generating and alerting platform 106 determines that the initialization request and the payment design features does not meet predetermined criteria, the payment card initialization request is cancelled in step 614.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the disclosure.

1. A method, comprising:
receiving, by a card generating and alerting computing platform, the card generating and alerting computing platform having at least one processor and memory, a payment card initialization request, the payment card initialization request including payment card design features for a payment card;
analyzing, by the card generating and alerting computing platform, the payment card initialization request including the payment card design features for the payment card;
determining that the initialization request and the payment design features meet predetermined criteria;
authorizing the issuance of the payment card based on the determination that the initialization request and the payment design features meet the predetermined criteria; and
generating a payment card based on the authorization, the generated payment card including the payment card design features.

2. The method of claim 1, further comprising determining a credit limit for the generated payment card.

3. The method of claim 1, wherein the payment card design features include at least one image.

4. The method of claim 1, wherein the payment card design features include at least one audio file.

5. The method of claim 1, wherein the payment card design features include at least one video clip.

6. The method of claim 1, wherein the payment card design features include at least one image and at least one audio file.

7. The method of claim 1, further comprising inserting by the card generating and alerting computing platform into the generated payment card at least one piece of information not decipherable in the visible spectrum.

8. The method of claim 7, wherein the at least one piece of information not decipherable in the visible spectrum includes a QR code.

9. The method of claim 1, further comprising inserting by the card generating and alerting computing platform into the generated payment card at least one piece of information not detectable in the visible spectrum.

10. One or more non-transitory computer-readable media storing instructions that when executed by a computing platform comprising at least one processor, a communication interface, and memory, cause the computing platform to:
receive a payment card initialization request, the payment card initialization request including payment card design features for a payment card;
analyze the payment card initialization request including the payment card design features for the payment card;
determine that the initialization request and the payment design features meet predetermined criteria;
authorize the issuance of the payment card based on the determination that the initialization request and the payment design features meet the predetermined criteria; and
generate a payment card based on the authorization, the generated payment card including the payment card design features.

11. The one or more non-transitory computer-readable media of claim 10, further including instructions that, when executed, cause the computing platform to determine a credit limit for the generated payment card.

12. The one or more non-transitory computer-readable media of claim 10, wherein the payment card design features include at least one image.

13. The one or more non-transitory computer-readable media of claim 10, wherein the payment card design features include at least one audio file.

14. The one or more non-transitory computer-readable media of claim 10, wherein the payment card design features include at least one video clip.

15. The one or more non-transitory computer-readable media of claim 10, wherein the payment card design features include at least one image and at least one audio file.

16. The one or more non-transitory computer-readable media of claim 10, further including instructions that, when executed, cause the computing platform to insert by the card generating and alerting computing platform into the generated payment card at least one piece of information not decipherable in the visible spectrum.

17. The one or more non-transitory computer-readable media of claim 16, wherein the at least one piece of information not decipherable in the visible spectrum includes a QR code.

18. A method, comprising:
transmitting, by a user device, the user device having at least one processor and memory, a payment card initialization request, the payment card initialization request including payment card design features for a payment card;
receiving, from a card computing platform, authorization for generation of the payment car, the authorization including at least a bank identification number, an expiration date, and a card verification value; and
generating a payment card using a 3D printer, the generated payment card including the card design features, the bank identification number, the expiration date, and the card verification value.

19. The method of claim 18, wherein the payment card design features include at least one image.

20. The method of claim 18, wherein the payment card design features include at least one audio file.
